(19) United States
(12) Patent Application Publication
(10) Pub. No.: US 2024/0227042 A1
(43) Pub. Date: Jul. 11, 2024

(54) POWER TOOL

(71) Applicant: MILWAUKEE ELECTRIC TOOL CORPORATION, Brookfield, WI (US)

(72) Inventors: Gerald A. Zucca, Akron, OH (US); Connor W. Mattox, Milwaukee, WI (US)

(21) Appl. No.: 18/563,267

(22) PCT Filed: May 24, 2022
(86) PCT No.: PCT/US2022/030684

§ 371 Date: Nov. 21, 2023

Related U.S. Application Data
(60) Provisional application No. 63/193,317, filed on May 26, 2021.

(51) Int. Cl. B23D 27/04; A01G 3/053; B26F 1/34

(52) U.S. Cl. CPC B23D 27/04; A01G 3/053; B26F 1/34

(57) ABSTRACT

A power tool includes a tool element extending from a housing, an electric motor disposed within the housing, a switch actuatable to energize the electric motor, an eccentric drive coupled to the electric motor and configured to convert a rotational input from the motor into a reciprocating motion of the tool element, and a controller configured to control operation of the electric motor. The electric motor is operable in a first mode to rotate in a first direction and in a second mode to rotate in a second direction opposite the first direction. The eccentric drive is configured to reciprocate the tool element when the electric motor is operated in the first mode and when the electric motor is operated in the second mode. The controller is configured to control the electric motor to alternate between the first mode and the second mode with each actuation of the switch.

### CROSS-REFERENCE TO RELATED APPLICATIONS

This application claims priority to co-pending U.S. Provisional Patent Application No. 63/193,317 filed on May 26, 2021, the entire contents of which is incorporated herein by reference.

### FIELD OF THE INVENTION

The present invention relates to power tools, and more specifically to reciprocating power tools.

### BACKGROUND OF THE INVENTION

One example of a reciprocating power tool is a handheld punch tool, also known as a nibbler, which operates by rapidly reciprocating a punch to cut through sheet metal, such as ductwork. Although nibblers are generally efficient and accurate tools for cutting through sheet metal, typical nibblers may experience a jam when attempting to cut thicker gauge sheet metal. In addition, typical nibblers are powered by an AC power source or compressed air, requiring a power cord or air hose that limits access and maneuverability.

### SUMMARY OF THE INVENTION

The present invention provides, in one aspect, a power tool including a housing, a tool element extending from the housing, an electric motor disposed within the housing and having a motor shaft configured to rotate about an axis, a switch supported by the housing, the switch being actuatable to energize the electric motor, an eccentric drive coupled to the electric motor, the eccentric drive configured to convert a rotational input from the motor shaft into a reciprocating motion of the tool element, and a controller configured to control operation of the electric motor. The electric motor is operable in a first mode to rotate the motor shaft about the axis in a first direction and in a second mode to rotate the motor shaft about the axis in a second direction opposite the first direction. The eccentric drive is configured to reciprocate the tool element when the electric motor is operated in the first mode and when the electric motor is operated in the second mode. The controller is configured to control the electric motor to alternate between the first mode and the second mode with each actuation of the switch.

The present invention provides, in one aspect, a power tool including a housing, a tool element extending from the housing, an electric motor disposed within the housing and having a motor shaft configured to rotate about an axis, a switch supported by the housing, the switch being actuatable to energize the electric motor, an eccentric drive coupled to the electric motor, the eccentric drive configured to convert a rotational input from the motor shaft into a reciprocating motion of the tool element, and a controller configured to control operation of the electric motor. The electric motor is operable in a first mode to rotate the motor shaft about the axis in a first direction and in a second mode to rotate the motor shaft about the axis in a second direction opposite the first direction. The eccentric drive is configured to reciprocate the tool element when the electric motor is operated in the first mode and when the electric motor is operated in the second mode. In response to the electric motor experiencing a stall, the controller automatically reverses a direction of rotation of the electric motor.

The present invention provides, in yet another aspect, a handheld punch tool including a housing, a die holder coupled to the housing, a die supported by the die holder, the die and the die holder defining a feed slot therebetween for receiving a workpiece to be cut, a punch configured to reciprocate within the die holder, and an electric motor disposed within the housing, the electric motor actuated by a switch and configured to rotate an eccentric shaft to reciprocate the punch. A direction of rotation of the electric motor reverses with each actuation of the switch.

Other features and aspects of the invention will become apparent by consideration of the following detailed description and accompanying drawings.

### BRIEF DESCRIPTION OF THE DRAWINGS

FIG. 1 is a perspective view of a punch tool according to an embodiment of the invention.

FIG. 2 is a cross-sectional view of the punch tool of FIG. 1, taken along line 2-2 in FIG. 1.

FIG. 3 is a perspective view illustrating a die holder of the punch tool of FIG. 1.

FIG. 4 is another perspective view of the die holder of the punch tool of FIG. 1.

FIG. 5 is a cross-sectional view of the punch tool of FIG. 1, taken along line 5-5 in FIG. 1.

FIG. 6 is a schematic diagram of a controller of the punch tool of FIG. 1

FIG. 7 is a cross-sectional view of a hedge trimmer according to an embodiment of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

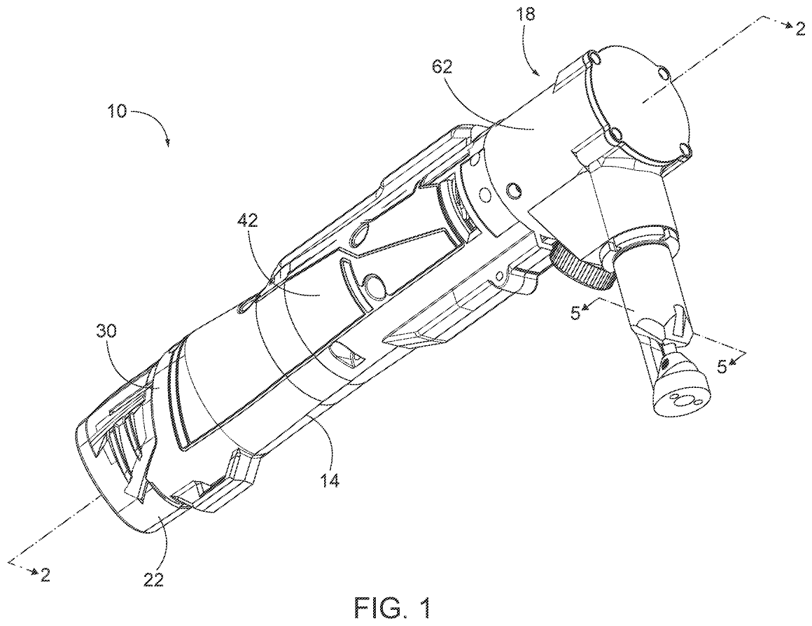

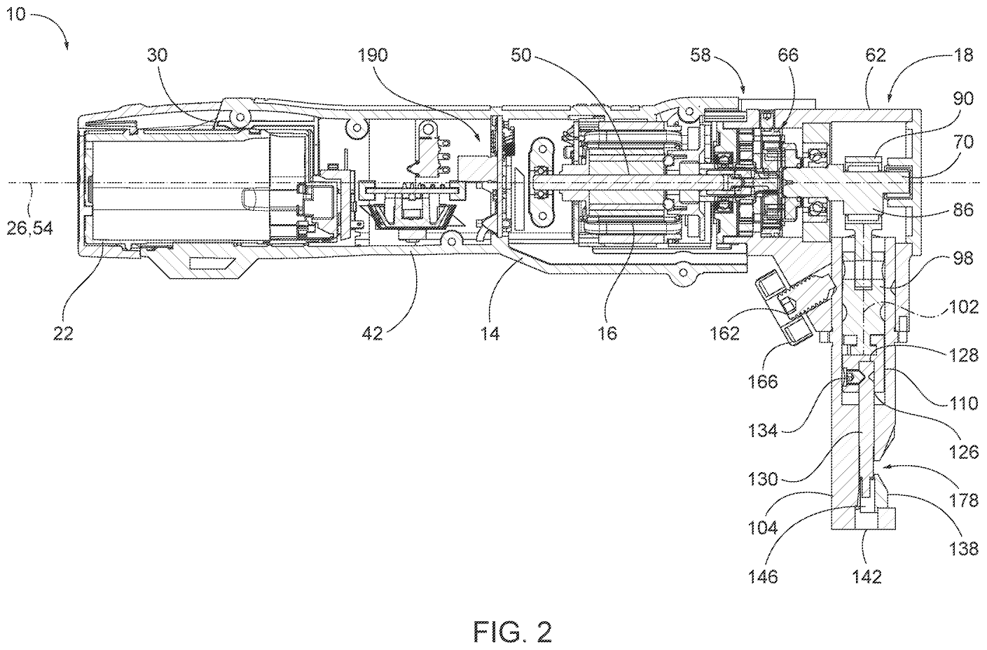

FIGS. 1-2 illustrate a power tool 10, in the form of a handheld punch tool or nibbler, including a housing 14, an electric motor 16 (FIG. 2) supported within the housing 14, a cutting head 18 coupled to a front portion of the housing 14, and a battery pack 22 for supplying power to the motor 16 for operating the cutting head 18. The illustrated battery pack 22 is a rechargeable battery pack with a plurality of lithium-based cells. The battery pack 22 may have a nominal output voltage of about 12 Volts. In other embodiments, the battery pack 22 may have other nominal output voltages (e.g., about 18 Volts or more). The features and advantages of the nibbler 10 according to the present disclosure may also be applied to corded nibblers or pneumatic nibblers, however.

With reference to FIG. 2, the housing 14 defines a first axis or housing axis 26, which is a longitudinal axis that extends centrally through the housing 14 along its length. The battery pack 22 is partially insertable into a battery receptacle 30 located at a rear portion of the housing 14, opposite the cutting head 18. In the illustrated embodiment, the battery pack 22 is insertable into the battery receptacle 30 along the first axis 26 to couple the battery pack 22 to the battery receptacle 30. This arrangement provides the nibbler 10 with a compact, in-line arrangement that facilitates use of the nibbler 10 in tight spaces.

The illustrated housing 14 includes a handle portion 42 (i.e. a portion of the housing 14 configured to be grasped by an operator during operation of the nibbler 10) having a generally cylindrical shape. The housing axis 26 extends centrally through the handle portion 42. However, the housing 14 may have a variety of other constructions such that the housing axis 26 may not extend through the handle portion 42. For example, the housing 14 may be generally ‘L’ or ‘T’ shaped with the handle portion 42 formed as a pistol grip. In such embodiments, the housing axis 26 may not extend through the handle portion 42 but rather may extend through another portion of the housing 14 containing the motor 16.

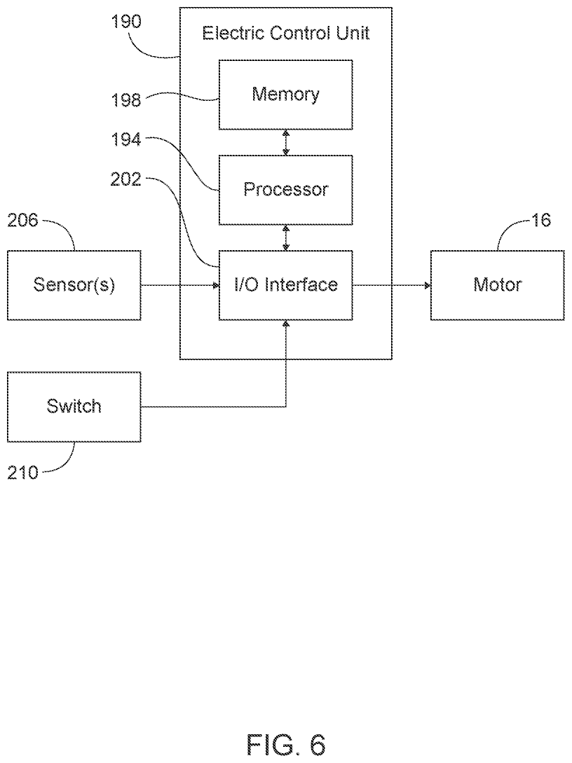

An on/off switch 210 (FIG. 6) is provided for activating the motor 16. The switch 210 may be supported by the housing 14 (e.g., on the handle portion 42). The motor 16 is a brushless DC motor in the illustrated embodiment and has a motor shaft or rotor 50 that is rotatable about a second axis or motor axis 54. The motor 16 is oriented such that the motor axis 54 is coaxial with the housing axis 26. As such, relationships described herein with reference to the motor axis 54 are equally applicable to the housing axis 26, and vice versa. However, in other embodiments, the motor axis 54 and the housing axis 26 may not be coaxial. The illustrated motor 16 has a first mode, in which the motor 16 drives the rotor 50 in a first direction about the motor axis 54, and a second mode, in which the motor 16 drives the rotor 50 in a second, opposite direction about the motor axis 54.

With continued reference to FIG. 2, the nibbler 10 includes a drive assembly 58 coupled to the motor shaft 50 and contained at least partially within a drive casing 62 of the cutting head 18. The drive assembly 58 includes a transmission 66 (e.g., a single or multi-stage planetary transmission, which may be shiftable to provide multiple speed/torque settings in some embodiments) that receives torque from the motor shaft 50 and an output shaft 70 driven by the transmission 66. The transmission 66 and the output shaft 70 are coaxial with the motor axis 54 in the illustrated embodiment; however, in other embodiments, the transmission 66 and/or the output shaft 70 may be oriented in other ways. In yet other embodiments, the output shaft 70 may be directly driven by the motor shaft 50.

The output shaft 70 includes an eccentric 86 surrounded by a yoke 90. The opposite end of the yoke 90 is pivotally coupled to a drive rod 98. Rotation of the output shaft 70—in either direction—thus causes reciprocation of the drive rod 98 along a third axis 102. In the illustrated embodiment, the third axis 102 is transverse to the first and second axes 26, 54; however, the orientation of the third axis 102 may vary in other embodiments.

With continued reference to FIG. 2, the drive rod 98 is received within an upper portion of a die holder 104 that is coupled to the drive casing 62. The die holder 104 also houses a clamp assembly 110 coupled to the drive rod 98 opposite the yoke 90. The clamp assembly 110 includes a clamping recess 126 that receives a first end 128 of a tool element, which, in the illustrated embodiment, is a punch 130. A set screw 134 engages the punch 130 to removably couple the punch 130 to the clamp assembly 110 for reciprocating therewith. The punch 130 can thus be conveniently removed and replaced when worn, or to substitute the punch 130 for a punch having a different size or geometry.

The cutting head 18 also includes a die 138 defining a passageway 146 through which the punch 130 reciprocates in response to reciprocation of the drive rod 98 and clamp assembly 110. The die 138 is removably coupled to the die holder 104 by a second set screw 142, which, in the illustrated embodiment, is accessible from a bottom end of the die holder 104. Thus, the die 138, like the punch 130, can be conveniently removed and replaced when worn, or to substitute the die 138 for a die having a different size or geometry.

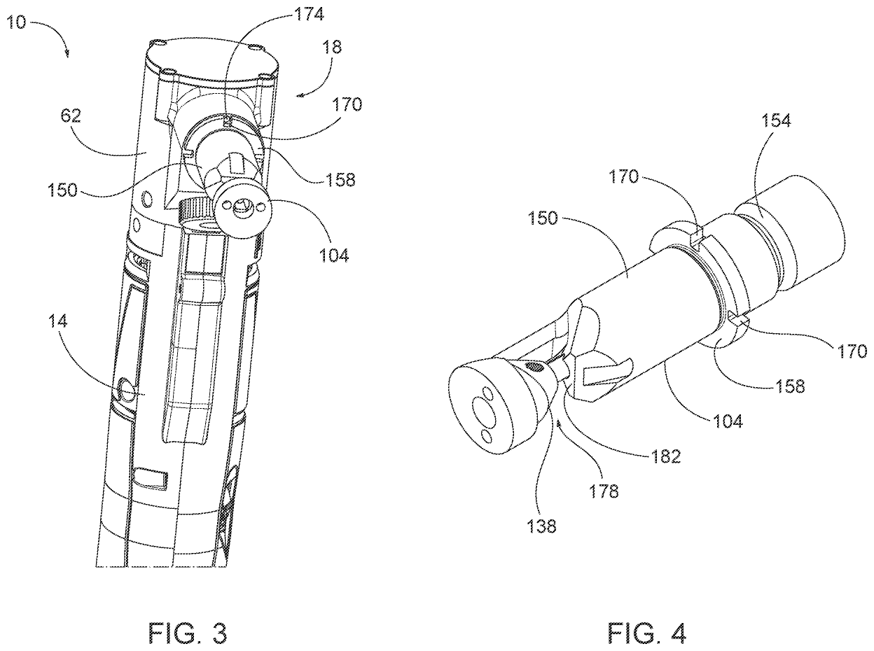

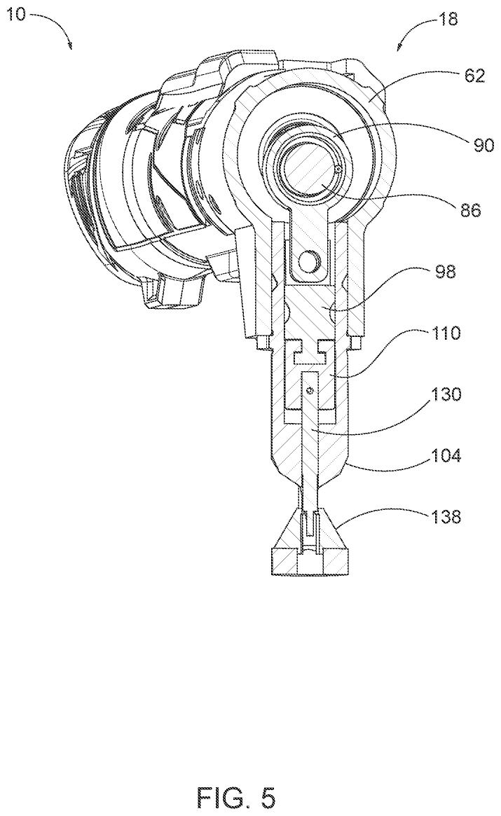

With reference to FIGS. 3-4, the die holder 104 in the illustrated embodiment includes a main body 150, an annular groove 154 recessed into the main body 150, and a flange 158 extending radially outwardly from the main body 150. The annular groove 154 receives the distal end of a set screw 162 (FIG. 2), which, in the illustrated embodiment, includes a knob 166 to facilitate hand adjustment of the set screw 162. The set screw 162 is oriented at an oblique angle relative to the axis 102, such that tightening the set screw 162 exerts both an axial and radial compressive force on the groove 154 of the main body 150 to secure the die holder 104 to the drive casing 62.

In the illustrated embodiment, the flange 158 of the die holder 104 includes a plurality of notches 170 extending radially inwardly from an outer circumferential edge of the flange 158. The notches 170 are configured to receive a pin or detent 174 extending from the drive casing 62 to define a plurality of rotational orientations of the die holder 104 relative to the drive casing 62. That is, loosening the set screw 162 allows the die holder 104 to be rotated relative to the drive casing 62, and each of the respective notches 170 can be aligned with the pin or detent 174 to set the die holder 104 in a predetermined rotational position. In the illustrated embodiment, the flange 158 includes four notches 170, each offset by 90 degrees, thereby providing the die holder 104 with four predetermined rotational positions. In other embodiments, the flange 158 may include any other number of notches 170 to provide a greater or lesser number of predetermined rotational positions.

Referring to FIG. 4, a feed slot 178 is defined between the die 138 and an opposing upper wall 182 of the die holder 104. Sheet material to be cut is fed into the feed slot 178 during operation and into the path of the reciprocating punch 130. By adjusting the orientation of the die holder 104 as described above, the feed slot 178 is repositionable to permit a user to hold the nibbler 10 in a desired orientation while guiding it along a cut line on a workpiece.

Referring to FIGS. 2 and 6, the illustrated nibbler 10 further includes a controller 190 for controlling operation of the motor 16. The controller 190 may include one or more printed circuit boards accommodating a plurality of electrical and electronic components that provide power, operational control, and protection to the motor 16, as well as other electronic components and modules of the controller 190. Referring to FIG. 6, the controller 190 includes, among other things, an electronic processor 194 (e.g., a programmable microprocessor, microcontroller, or similar device), non-transitory, machine-readable memory 198, and an input/output interface 202. The electronic processor 194 is communicatively coupled to the memory 198 and configured to retrieve from memory 198 and execute, among other things, instructions related to the control processes and methods described herein. In other embodiments, the controller 190 includes additional, fewer, or different components. For example, the memory 198 may be an internal memory of the electronic processor 194 (e.g., microcontroller), thereby decreasing the total number of components in the controller 190.

In operation of the nibbler 10, an operator depresses the switch 210, causing the controller 190 to activate the motor 16 via the input/output interface 202. The motor 16 continuously supplies torque to the drive assembly 58 via the motor shaft 50 (FIG. 2). The drive assembly 58 in turn converts the rotational input from the motor shaft 50 into reciprocating motion of the punch 130.

In more detail, the motor shaft 50 drives the output shaft 70 via the transmission 66. As the output shaft 70 rotates, the drive rod 98 of the cutting head 18 reciprocates along the third axis 102 due to the motion of the yoke 90. The drive rod 98 reciprocates the clamp assembly 110, which in turn reciprocates the punch 130. The operator may then guide the cutting head 18 onto a piece of sheet metal or another workpiece to be cut. As the workpiece enters the feed slot 178 in the die holder 104, the punch element 186 of the reciprocating punch 130 repeatedly and incrementally shears small pieces of the workpiece against the die 138 to create an elongated cut.

During operation, it may be possible for the punch 130 to become wedged against the workpiece (e.g., if the punch element 186 is worn, the punch element 186 encounters an imperfection in the workpiece, or the like), resulting in a jam in which the motor 16 is unable to drive the punch 130 through the workpiece. When a jam occurs, the motor 16 may stall, such that the motor shaft 50 slows or stops rotating.

Rather than continuing to try to force the punch 130 through the workpiece, which may cause stress on the motor 16 and the drive assembly 58, the controller 190 reverses the operating direction of the motor 16 to begin retracting the punch 130 out of the workpiece, which may clear the jam. Because the drive assembly 58 produces reciprocating motion of the punch 130 in either rotational direction of the motor shaft 50, the motor 16 continues to operate in the reversed direction to reciprocate the punch 130, thereby allowing the nibbler 10 to continue cutting the workpiece. In the illustrated embodiment, the direction of rotation of the motor shaft 50 is reversed each time the operator depresses the switch 210 to activate the motor 16. Thus, when the nibbler 10 experiences a jam, the operator simply releases and re-depresses the switch 210 to reverse the rotational direction of the motor shaft 50 (that is, toggle between the first and second operating modes of the motor 16), and then continue the cutting operation.

In some embodiments, the controller 190 may monitor one or more aspects of the nibbler 10 during operation in order to determine that a stall of the motor 16—and thus, a jam—has occurred. For example, with reference to FIG. 6, a sensor 206 communicates with the controller 190 via the input/output interface 202. In some embodiments, the sensor 206 monitors rotation of the motor shaft 50 and/or any other components of the drive assembly 58, and the controller 190 determines that the motor 16 is an overloaded or stalled state if the feedback provided by the sensor 206 indicates that the motor shaft 50 is rotating at a slower rate than a target or commanded rate. In such embodiments, the sensor 206 may include an encoder, a Hall effect sensor, or any other sensor capable of measuring the rotational speed of the monitored component(s) of the drive assembly 58.

In another embodiment, the sensor 206 may include a motor current sensor able to detect changes in current being supplied to the motor. In such embodiments, the controller 190 may determine that the motor 16 is in an overloaded or stalled state if the sensor 206 indicates a spike in motor current. In yet other embodiments, other types of sensors may be used to determine whether the motor 16 has stalled.

In response to determining that a stall has occurred, the controller 190 may then automatically shut off the motor 16 and/or toggle between the first and second modes to reverse the rotational direction of the motor shaft 50 and thereby clear the jam.

The automatic reversing and jam clearing functionality of the nibbler 10 may be advantageously incorporated into any power tool having an eccentric drive mechanism. For example, the automatic reversing and jam clearing may be incorporated into hedge trimmers, reciprocating saws, jig saws, and the like. While this is not an exhaustive list, each of these power tools is able to release a jam by reversing the direction of motion of a reciprocating tool element.

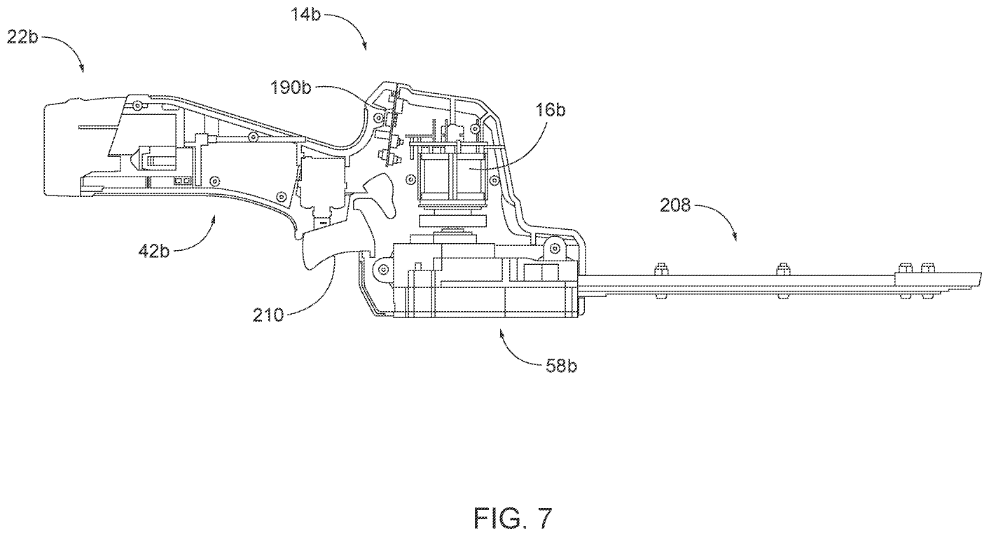

As an example, FIG. 7 illustrates a power tool according to another embodiment, in the form of a hedge trimmer. Features of the hedge trimmer corresponding with features of the nibbler 10 described above are given like reference numerals appended with the letter ‘b.’

The hedge trimmer includes a housing 14b supporting an electric motor 16b, a tool element or trimmer blade 208 extending from a front portion of the housing 14b, and a battery pack 22b for supplying power to the motor 16b to operate the trimmer. A switch 210 is located on a handle portion 42b of the housing 14b for energizing the motor 16b. The hedge trimmer further includes a drive assembly 58b coupled to the electric motor 16b and the trimmer blade 208. Included in the drive assembly 58b is an eccentric drive (not shown) for converting rotational motion of the electric motor 16b to reciprocating motion of the trimmer blade 208. A controller 190b is configured to control the motor 16b based on the state of the switch 210. In some embodiments, the controller 190b reverses the rotational direction of the motor 16b with each actuation of the switch 210. In other embodiments, the controller 190b is configured to detect a stall of the motor 16b, stop the motor 16b when a stall is detected, and then automatically reverse the direction of rotation of the motor 16b upon a subsequent actuation of the switch 210. In yet other embodiments, the controller 190b may automatically operate the motor 16b in the reversed direction without requiring an additional actuation of the switch 210.

Although the invention has been described in detail with reference to certain preferred embodiments, variations and modifications exist within the scope and spirit of one or more independent aspects of the invention as described.

Various features and aspects of the present invention are set forth in the following claims.

What is claimed is:

1. A power tool comprising:
a housing;
a tool element extending from the housing;
an electric motor disposed within the housing and having a motor shaft configured to rotate about an axis;
a switch supported by the housing, the switch being actuatable to energize the electric motor;
an eccentric drive coupled to the electric motor, the eccentric drive configured to convert a rotational input from the motor shaft into a reciprocating motion of the tool element; and
a controller configured to control operation of the electric motor,
wherein the electric motor is operable in a first mode to rotate the motor shaft about the axis in a first direction and in a second mode to rotate the motor shaft about the axis in a second direction opposite the first direction,
wherein the eccentric drive is configured to reciprocate the tool element when the electric motor is operated in the first mode and when the electric motor is operated in the second mode, and
wherein the controller is configured to control the electric motor to alternate between the first mode and the second mode with each actuation of the switch.

2. The power tool of claim 1, wherein the power tool is a handheld punch tool.

3. The power tool of claim 1, wherein the power tool is a hedge trimmer.

4. The power tool of claim 1, further comprising a sensor configured to detect a jam.

5. The power tool of claim 4, wherein the controller is configured to stop the rotation of the motor shaft in response to the sensor detecting a jam.

6. The power tool of claim 1, further comprising a battery pack removably coupled to the housing for providing power to the electric motor.

7. A power tool comprising:
a housing;
a tool element extending from the housing;
an electric motor disposed within the housing and having a motor shaft configured to rotate about an axis;
a switch supported by the housing, the switch being actuatable to energize the electric motor;
an eccentric drive coupled to the electric motor, the eccentric drive configured to convert rotational input from the motor shaft into a reciprocating motion of the tool element; and
a controller configured to control operation of the electric motor,
wherein the controller is configured to automatically reverse a direction of rotation of the motor shaft in response to the electric motor experiencing a stall.

8. The power tool of claim 7, wherein the power tool is a handheld punch tool.

9. The power tool of claim 7, wherein the power tool is a hedge trimmer.

10. The power tool of claim 7, further comprising a sensor configured to monitor rotation of the motor shaft, wherein the controller is configured to determine that the electric motor is experiencing a stall based on feedback from the sensor.

11. The power tool of claim 7, further comprising a sensor configured to monitor current supplied to the electric motor, wherein the controller is configured to determine that the electric motor is experiencing a stall based on feedback from the sensor.

12. The power tool of claim 7, wherein the controller is configured to automatically reverse the direction of rotation of the motor shaft upon a subsequent actuation of the switch after the electric motor experiences the stall.

13. A handheld punch tool comprising:
a housing;
a die holder coupled to the housing;
a die supported by the die holder, the die and the die holder defining a feed slot therebetween for receiving a workpiece to be cut;
a punch configured to reciprocate within the die holder; and
an electric motor disposed within the housing, the electric motor actuated by a switch and configured to rotate an eccentric shaft to reciprocate the punch,
wherein a direction of rotation of the electric motor reverses with each actuation of the switch.

14. The handheld punch tool of claim 13, further comprising a controller and a sensor in communication with the controller, wherein the controller is configured to change an operating state of the electric motor in response to the sensor detecting a jam.

15. The handheld punch tool of claim 14, wherein the controller is configured to de-energize the electric motor in response to the sensor detecting a jam.

16. The handheld punch tool of claim 14, wherein the sensor includes a Hall effect sensor.

17. The handheld punch tool of claim 14, wherein the sensor includes a motor current sensor.

18. The handheld punch tool of claim 13, wherein the punch is configured to reciprocate along an axis perpendicular to an axis of rotation of the eccentric shaft.

19. The handheld punch tool of claim 13, further comprising a battery pack removably coupled to the housing for providing power to the electric motor.

20. The handheld punch tool of claim 14, wherein the controller includes a printed circuit board supported within the housing.
